(19) United States
(12) Patent Application Publication
(10) Pub. No.: US 2019/0087307 A1
(43) Pub. Date: Mar. 21, 2019

(54) METHOD AND APPARATUS FOR DEVELOPING UNMANNED VEHICLE APPLICATION

(71) Applicant: BEIJING BAIDU NETCOM SCIENCE AND TECHNOLOGY CO., LTD., Beijing (CN)

(72) Inventors: Jun Zhan, Beijing (CN); Qiyi Jiang, Beijing (CN); Chao Wang, Beijing (CN)

(73) Assignee: BEIJING BAIDU NETCOM SCIENCE AND TECHNOLOGY CO., LTD., Beijing (CN)

(21) Appl. No.: 15/534,762

(22) PCT Filed: Jan. 3, 2017
(86) PCT No.: PCT/CN2017/000041

§ 371 Date: Jun. 9, 2017

(30) Foreign Application Priority Data
Oct. 13, 2016 (CN) 201610894665.0

(51) Int. Cl. G06F 11/36; G06F 8/30; B64C 39/02

(52) U.S. Cl. CPC G06F 11/3612; G06F 8/30; B64C 2201/146; B64C 39/024; G06F 11/3664

(57) ABSTRACT

The present disclosure discloses a method and apparatus for developing an unmanned vehicle application. A specific embodiment of the method comprises: acquiring a test result of executing a test operation on an unmanned vehicle application in a plurality of test scenarios; and performing a repair operation on the unmanned vehicle application by using test scenario data of test scenarios in which a problem is detected in the test result, a container image comprising an operating system-level component required to deploy an operation of a unmanned vehicle component, an image layer of a third-party dependent library, an application code for deploying the unmanned vehicle application and an image layer of an operation environment of the unmanned vehicle application. This embodiment can significantly speed up the development efficiency of the unmanned vehicle application.

### CROSS-REFERENCE TO RELATED APPLICATION

This application is related to and claims priority from Chinese Application No. 201610894665.0, filed on Oct. 13, 2016 and entitled “Method and Apparatus for Development Unmanned Vehicle Application,” the entire disclosure of which is hereby incorporated by reference.

### TECHNICAL FIELD

The present disclosure relates to the field of computer technology, specifically to the field of unmanned vehicle technology, and more specifically to a method and apparatus for developing an unmanned vehicle application.

### BACKGROUND

In the development of unmanned vehicles, the role of the simulator is essential. The simulator provides an off-line integrated testing environment for the various modules of the unmanned vehicle. The scenario data collected for the unmanned vehicle is very critical information, and to use the data, one must rely on the simulator.

However, in the prior art, the simulator is online or offline, and sometimes the offline version is only a terminal of a cloud simulator. Either way, it is difficult to take into account both the need of the research-development and test staff for rapid development and the need for rapid cloud massive simulation. In addition, the precise pushing of the local environment to the cloud is also very complex and almost impossible to achieve.

### SUMMARY

An objective of the present disclosure is to provide a method and apparatus for developing an unmanned vehicle application, in order to solve the technical problem mentioned in the foregoing Background section.

In a first aspect, the present disclosure provides a method for developing a unmanned vehicle application, the method comprises: acquiring a test result of executing a test operation on an unmanned vehicle application in a plurality of test scenarios; and performing a repair operation on the unmanned vehicle application by using test scenario data of test scenarios in which a problem is detected in the test result, a container image comprising an operating system-level component required to deploy an operation of a unmanned vehicle component, an image layer of a third-party dependent library, an application code for deploying the unmanned vehicle application and an image layer of an operation environment of the unmanned vehicle application; wherein the repair operation comprises: pushing the test scenario data into the container image to form a to-be-repaired container image and issuing the to-be-repaired container image to a research-development or test terminal to start the research-development or test terminal; receiving a repaired container image uploaded by the research-development or test terminal, wherein the repaired container image is an image generated by repairing the application code of the unmanned vehicle application by a research-development or test staff with the started to-be-repaired container image.

In some embodiments, the method further comprises: executing a regression test on the unmanned vehicle application of the repaired container image in the plurality of test scenarios.

In some embodiments, the method further comprises: repeating the repair operation, if a problem is detected in the regression test.

In some embodiments, the acquiring a test result after executing a test operation on an unmanned vehicle application in a plurality of test scenarios comprises: starting the container image and applying an offline test to the unmanned vehicle application in a plurality of test scenarios simulated by a simulator, respectively; and acquiring a test result of the offline test in the plurality of test scenarios.

In some embodiments, the acquiring a test result after executing a test operation on an unmanned vehicle application in a plurality of test scenarios comprises: acquiring a test result of an on-road test of an unmanned vehicle deployed with the unmanned vehicle application in a plurality of test scenarios.

In some embodiments, the container image is a Docker image.

In a second aspect, the present disclosure provides a method for developing an unmanned vehicle application, comprising: receiving a to-be-repaired container image issued from a cloud server, wherein the cloud server is pre-established with a container image comprising an operating system-level component required to deploy an operation of a unmanned vehicle component, an image layer of a container image of a third-party dependent library, an application code for deploying the unmanned vehicle application and an image layer of an operation environment of the unmanned vehicle application, the to-be-repaired container image being an image formed by pushing test scenario data of test scenarios in which a problem is detected during testing into the container image after the cloud server acquires a test result of executing a test operation on the unmanned vehicle application in a plurality of test scenarios; starting the to-be-repaired container image; generating a repaired container image after repairing, in response to a repair operation on the application code of the unmanned vehicle application by a research-development or test staff with the started to-be-repaired container image; and uploading the repaired container image to the cloud server.

In a third aspect, the present disclosure provides an apparatus for developing an unmanned vehicle application, comprising: an acquisition unit, configured to acquire a test result of executing a test operation on an unmanned vehicle application in a plurality of test scenarios; and a repairing unit, configured to perform a repair operation on the unmanned vehicle application by using test scenario data of test scenarios in which a problem is detected in the test result, a container image comprising an operating system-level component required to deploy an operation of a unmanned vehicle component, an image layer of a third-party dependent library, an application code for deploying the unmanned vehicle application and an image layer of an operation environment of the unmanned vehicle application; wherein the repair operation comprises: pushing the test scenario data into the container image to form a to-be-repaired container image and issuing the to-be-repaired container image to a research-development or test terminal to start the research-development or test terminal; receiving a repaired container image uploaded by the research-development or test terminal, wherein the repaired container image is an image generated by repairing the application code of the unmanned vehicle application by a research-development or test staff with the started to-be-repaired container image.

In some embodiments, the apparatus further comprises: a regression test unit, configured to execute a regression test on the unmanned vehicle application of the repaired container image in the plurality of test scenarios.

In some embodiments, the apparatus further comprises: a repair repeating unit, configured to repeat the repair operation, if a problem is detected in the regression test.

In some embodiments, the acquisition unit is further configured to: start the container image and applying an offline test to the unmanned vehicle application in a plurality of test scenarios simulated by a simulator, respectively; and acquire a test result of the offline test in the plurality of test scenarios.

In some embodiments, the acquisition unit is further configured to: acquire a test result of an on-road test of an unmanned vehicle deployed with the unmanned vehicle application in a plurality of test scenarios.

In some embodiments, the container image is a Docker image.

In a fourth aspect, the present disclosure provides an apparatus for developing an unmanned vehicle application, comprising: a receiving unit, configured to receive a to-be-repaired container image issued from a cloud server, wherein the cloud server is pre-established with a container image comprising an operating system-level component required to deploy an operation of a unmanned vehicle component, an image layer of a container image of a third-party dependent library, an application code for deploying the unmanned vehicle application and an image layer of an operation environment of the unmanned vehicle application, the to-be-repaired container image being an image formed by pushing test scenario data of test scenarios in which a problem is detected during testing into the container image after the cloud server acquires a test result of executing a test operation on the unmanned vehicle application in a plurality of test scenarios; an starting unit, configured to start the to-be-repaired container image; a generating unit, configured to generate a repaired container image after repairing, in response to a repair operation on the application code of the unmanned vehicle application by a research-development or test staff with the started to-be-repaired container image; and an uploading unit, configured to upload the repaired container image to the cloud server.

By acquiring test results of performing tests to the unmanned vehicle application in a plurality of test scenarios on the cloud server, and achieving a consistency of the terminal with the environment in the cloud server through the container image, the method and apparatus for developing an unmanned vehicle application provided in the present disclosure may use the test scenarios with detected problems on the terminal to repair the unmanned vehicle application, and thus may significantly speed up the development efficiency.

### BRIEF DESCRIPTION OF THE DRAWINGS

Other features, objectives and advantages of the present disclosure will become more apparent upon reading the detailed description to non-limiting embodiments with reference to the accompanying drawings, wherein:

FIG. 1 is an exemplary system architecture diagram in which the present disclosure may be applied;

FIG. 2 is a flowchart of an embodiment of a method for developing the unmanned vehicle application according to the present disclosure;

FIG. 3 is a flowchart of another embodiment of the method for developing the unmanned vehicle application according to the present disclosure;

FIG. 4 is a schematic structural diagram of an embodiment of an apparatus for developing the unmanned vehicle application according to the present disclosure;

FIG. 5 is a schematic structural diagram of another embodiment of the apparatus for developing the unmanned vehicle application according to the present disclosure; and

FIG. 6 is a schematic structural diagram of a computer system adapted to implement a terminal device or server according to embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant invention, rather than limiting the invention. In addition, it should be noted that, for the ease of description, only the parts related to the relevant invention are shown in the accompanying drawings.

It should be noted that the embodiments in the present disclosure and the features in the embodiments may be combined with each other on a non-conflict basis. The present disclosure will be described below in detail with reference to the accompanying drawings and in combination with the embodiments.

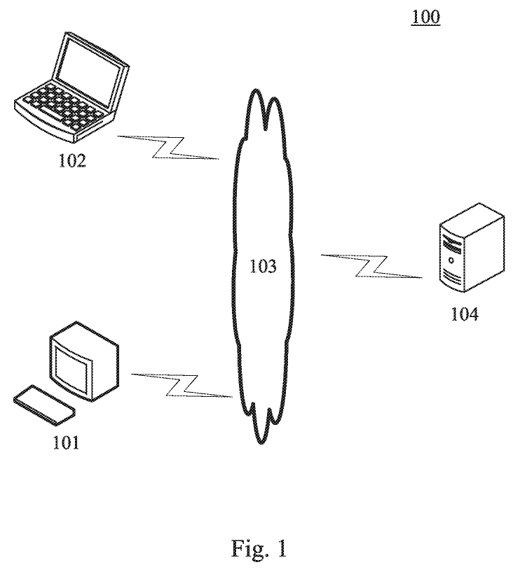

FIG. 1 shows an exemplary system architecture 100 of the embodiments of the method or apparatus for developing the unmanned vehicle application in which the present disclosure may be applied.

As shown in FIG. 1, the system architecture 100 may include terminal devices 101, 102, a network 103 and a server 104. The network 103 serves as a medium providing a communication link between the terminal devices 101, 102 and the server 104. The network 103 may include various types of connections, such as wired or wireless communication links, or optical fibers and the like.

The terminal device 101 may be various electronic devices with a display screen, including but not limited to laptop computers, desktop computers and etc. The user may use the terminal devices 101, 102 to develop or test the application. The terminal device may also interact with the server 104 over the network 103 to receive or send messages and the like.

The server 104 may be a server providing various services, e.g., a cloud server providing support to the information loaded on the terminal devices 101 and 102. The cloud server may issue data (e.g., a container image) to the terminal devices 101, 102, or may receive information uploaded by the terminal devices 101, 102.

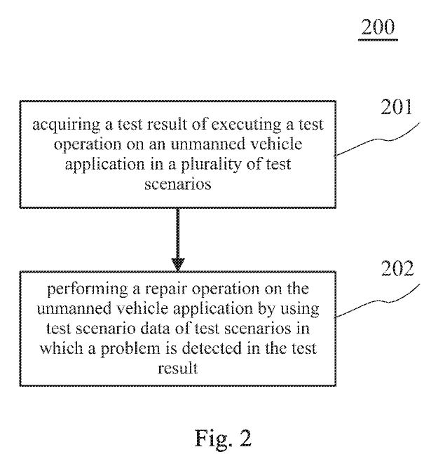

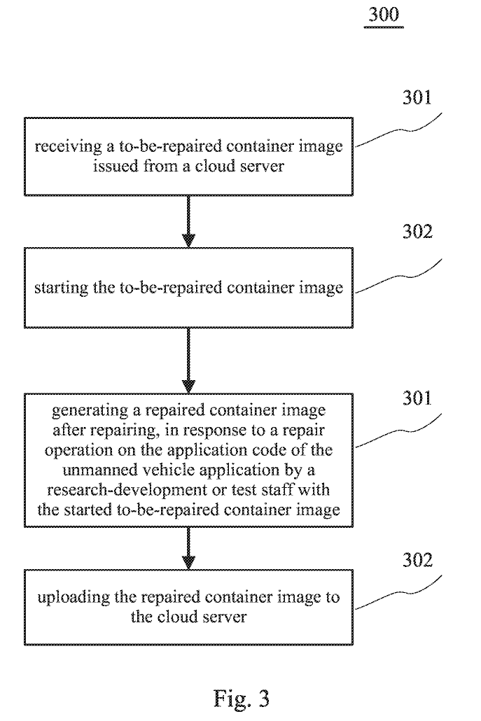

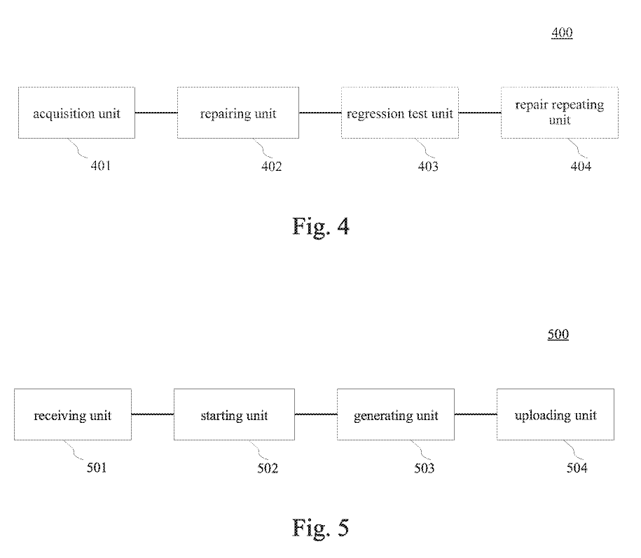

It should be noted that the method for developing unmanned vehicle application provided by the embodiment corresponding to FIG. 2 of the present disclosure is generally executed by the cloud server 104, and correspondingly, the apparatus for developing unmanned vehicle application provided by the embodiment corresponding to FIG. 4 is generally installed in the cloud server 104. The method for developing unmanned vehicle application provided by the embodiment corresponding to FIG. 3 is generally executed by the terminals 101, 102, and correspondingly, the apparatus for developing unmanned vehicle application provided by the embodiment corresponding to FIG. 5 is generally installed in the terminals 101, 102.

It should be appreciated that the numbers of the terminal devices, the networks and the servers in FIG. 1 are merely illustrative. Any number of terminal devices, networks and servers may be provided based on the actual requirements.

With further reference to FIG. 2, a flow 200 of an embodiment of the method for developing the unmanned vehicle application according to the present disclosure is shown. The method for developing the unmanned vehicle application includes the following steps:

Step 201, acquiring a test result of executing a test operation on an unmanned vehicle application in a plurality of test scenarios.

In the present embodiment, an electronic device (e.g., the terminal as illustrated in FIG. 1) on which the method for developing the unmanned vehicle application operate may acquire locally or remotely a test result of performing a test operation on an unmanned vehicle application in a plurality of test scenarios respectively.

In some alternative implementations of the present embodiment, the step 201 includes: starting the container image and applying an offline test to the unmanned vehicle application in a plurality of test scenarios simulated by a simulator, respectively; and acquiring a test result of the offline test in the plurality of test scenarios.

In some alternative implementations of the present embodiment, the step 202 includes: starting the container image and applying an offline test to the unmanned vehicle application in a plurality of test scenarios simulated by a simulator, respectively; and acquiring a test result of the offline test in the plurality of test scenarios.

In some alternative implementations of the present embodiment, the step 201 includes: acquiring a test result of an on-road test of an unmanned vehicle deployed with the unmanned vehicle application in a plurality of test scenarios.

Step 202, performing a repair operation on the unmanned vehicle application by using test scenario data of test scenarios in which a problem is detected in the test result.

In the present embodiment, based on the test result acquired in step 201, the electronic device (e.g., the cloud server as illustrated in FIG. 1) may first analyse the test result to determine the test scenarios in which problems occur during testing. After that, the electronic device may acquire the test scenario data in which problems are detected and perform a repair operation on the unmanned vehicle application using the test scenario data.

The repair operation specifically includes the following specific steps: first, the electronic device may push the test scenario data into the container image to form a container image to be repaired; then, the electronic device may issue the container image to be repaired to a research-development or test terminal for the research-development or test terminal to start; after that, the electronic device may receive a repaired container image uploaded by the research-development or test terminal, wherein the repaired container image is an image generated by repairing the unmanned vehicle application by the research-development or test staff through the started container image to be repaired.

In practice, the research-development or test terminal may use the test scenario data to reproduce the test scenario in which a problem is detected, when the research-development or test terminal starts the container image to be repaired. The research-development or test staff may debug and compile the unmanned vehicle application in the test scenario to repair the application code of the unmanned vehicle application. After that, the research-development or test terminal may use the repaired application code to replace the problematic application code to form a repaired container image. Finally, the research-development or test terminal may upload the repaired container image to the cloud server, so that the cloud server may acquire the repaired container image.

In some alternative implementations of the present embodiment, after step 202, the method further includes: executing a regression test on the unmanned vehicle application of the repaired container image in the plurality of test scenarios. This implementation can be verified by a regression test on whether new problems occur to the repaired unmanned vehicle application.

In some alternative implementations of the previous implementation, the method further comprises: repeating the repair operation, if a problem is detected in the regression test. In this implementation, the electronic device may perform a regression test on a plurality of test scenarios for the unmanned vehicle application in the repaired container image; when a problem occurs in the regression test, the above repair operation continues. When a problem occurs in the regression test of this implementation, the test scenarios in which problems are detected during testing may be repeatedly pushed to the container image and issued to the terminal, thus the test scenarios in which problems are detected may be used to continuously debug and compile the unmanned vehicle application, until the problems are finally repaired.

By acquiring test results of performing tests to the unmanned vehicle application in a plurality of test scenarios on the cloud server, and achieving a consistency of the terminal with the environment in the cloud server through the container image, the method provided by the embodiment of the present disclosure may use the test scenarios with detected problems on the terminal to repair the unmanned vehicle application, thus may significantly speeding up the development efficiency.

With further reference to FIG. 3, a flow 300 of another embodiment of the method for developing the unmanned vehicle application is shown. The flow 300 of the method for developing the unmanned vehicle application includes the following steps:

Step 301, receiving a to-be-repaired container image issued from a cloud server.

In the present embodiment, the cloud server is pre-established with a container image, the container image including an operating system-level component required to deploy operation of a unmanned vehicle component, an image layer of the container image of a third-party dependent library, an application code for deploying the unmanned vehicle application and an image layer of an operation environment of the unmanned vehicle application. The cloud server may first acquire test results of performing the test operation on the unmanned vehicle application in the plurality of test scenarios respectively. Then, the cloud server may push the test scenario data of the test scenarios in which problems occurred during testing to the container image to form the image to be repaired and issue it to the terminal. In this way, the electronic device (e.g., the terminal device in FIG. 1) on which the method for developing the unmanned vehicle application operate may receive the container image to be repaired issued by the cloud server.

Step 302, starting the to-be-repaired container image.

In the present embodiment, based on the container image to be repaired received in step 301, the electronic device may start the container image to be repaired.

Step 303, generating a repaired container image after repairing, in response to a repair operation on the application code of the unmanned vehicle application by a research-development or test staff with the started to-be-repaired container image.

In the present embodiment, after the container image to be repaired is started in step 302, the research-development or test staff repair the application code of the unmanned vehicle application through the started container image to be repaired. Specifically, after the container image to be repaired is started, the electronic device may use the testing data to reproduce the test scenario in which a problem is detected during the testing in the container generated by the container image to be repaired. The research-development or test staff may debug and compile the unmanned vehicle application by the test scenario to repair the detected problem. Therefore, the electronic device may detect the repair operation to the application code of the unmanned vehicle application by the research-development or test staff through the started container image to be repaired, thus generating a repaired container image repaired after the repair operation is performed.

Step 304, uploading the repaired container image to the cloud server.

In the present embodiment, based on the repaired container image generated in step 304, the electronic device may upload the repaired container image to the cloud server, thus completing the repairing to the application code of the unmanned vehicle application. By acquiring test results of performing tests to the unmanned vehicle application in a plurality of test scenarios on the cloud server, and achieving a consistency of the terminal with the environment in the cloud server through the container image, the method provided by the embodiment of the present disclosure may use the test scenarios with detected problems on the terminal to repair the unmanned vehicle application, thus may significantly speeding up the development efficiency.

With further reference to FIG. 4, as an implementation to the method illustrated in the above figures, the present disclosure provides an embodiment of an apparatus for developing the unmanned vehicle application. The apparatus embodiment corresponds to the method embodiment shown in FIG. 2, and may be specifically applied to various electronic devices.

As shown in FIG. 4, the apparatus 400 for developing an unmanned vehicle application according to the present embodiment comprises: an acquisition unit 401 and a repairing unit 402. The acquisition unit 401 is configured to acquire a test result of executing a test operation on an unmanned vehicle application in a plurality of test scenarios. The repairing unit 402 is configured to perform a repair operation on the unmanned vehicle application by using test scenario data of test scenarios in which a problem is detected in the test result, a container image comprising an operating system-level component required to deploy an operation of a unmanned vehicle component, an image layer of a third-party dependent library, an application code for deploying the unmanned vehicle application and an image layer of an operation environment of the unmanned vehicle application; wherein the repair operation comprises: pushing the test scenario data into the container image to form a to-be-repaired container image and issuing the to-be-repaired container image to a research-development or test terminal to start the research-development or test terminal; receiving a repaired container image uploaded by the research-development or test terminal, wherein the repaired container image is an image generated by repairing the application code of the unmanned vehicle application by a research-development or test staff with the started to-be-repaired container image.

In the present embodiment, the specific operation of the acquisition unit 401 and the repairing unit 402 of the apparatus 400 for developing the unmanned vehicle application may be refer to step 201 and step 202 in the corresponding embodiment in FIG. 2, therefore detailed description thereof is omitted.

In some alternative implementations of the present embodiment, the apparatus 400 further includes: a regression test unit 403, wherein the regression test unit 403 is configured to execute a regression test on the unmanned vehicle application of the repaired container image in the plurality of test scenarios. The specific operation of this implementation may be referring to the relevant implementation in the corresponding embodiment in FIG. 2.

In some alternative implementations of the present embodiment, the apparatus 400 further comprises: a repair repeating unit 404. The repair repeating unit 404 is configured to repeat the repair operation, if a problem is detected in the regression test. The specific operation of this implementation may be referring to the relevant implementation in the corresponding embodiment in FIG. 2.

In some alternative implementations of the present embodiment, the acquisition unit 401 is further configured to: start the container image and applying an offline test to the unmanned vehicle application in a plurality of test scenarios simulated by a simulator, respectively; and acquire a test result of the offline test in the plurality of test scenarios. The specific operation of this implementation may be referring to the relevant implementation in the corresponding embodiment in FIG. 2.

In some alternative implementations of the present embodiment, the acquisition unit 401 is further configured to: acquire a test result of an on-road test of an unmanned vehicle deployed with the unmanned vehicle application in a plurality of test scenarios. The specific operation of this implementation may be referring to the relevant implementation in the corresponding embodiment in FIG. 2.

In some alternative implementations of the present embodiment, the container image is a Docker image. The specific operation of this implementation may be referring to the relevant implementation in the corresponding embodiment in FIG. 2.

With further reference to FIG. 5, as an implementation to the method illustrated in the above figures, the present disclosure provides an embodiment of an apparatus for developing the unmanned vehicle application. The apparatus embodiment corresponds to the method embodiment shown in FIG. 3, and may be specifically applied to various electronic devices.

As shown in FIG. 5, the apparatus 500 for developing the unmanned vehicle application according to the present embodiment comprises: a receiving unit 501, a starting unit 502, a generating unit 503 and an uploading unit 504. The receiving unit 501 is configured to receive a to-be-repaired container image issued from a cloud server, wherein the cloud server is pre-established with a container image comprising an operating system-level component required to deploy an operation of a unmanned vehicle component, an image layer of a container image of a third-party dependent library, an application code for deploying the unmanned vehicle application and an image layer of an operation environment of the unmanned vehicle application, the to-be-repaired container image being an image formed by pushing test scenario data of test scenarios in which a problem is detected during testing into the container image after the cloud server acquires a test result of executing a test operation on the unmanned vehicle application in a plurality of test scenarios. The starting unit 502 is configured to start the to-be-repaired container image. The generating unit 503 is configured to generate a repaired container image after repairing, in response to a repair operation on the application code of the unmanned vehicle application by a research-development or test staff with the started to-be-repaired container image. The uploading unit 504 is configured to upload the repaired container image to the cloud server.

In the present embodiment, the specific operation of the receiving unit 501, the starting unit 502, the generating unit 503 and the uploading unit 504 may be refer to step 301, step 302, step 303 and step 304 in the corresponding embodiment in FIG. 3, therefore detailed description thereof is omitted.

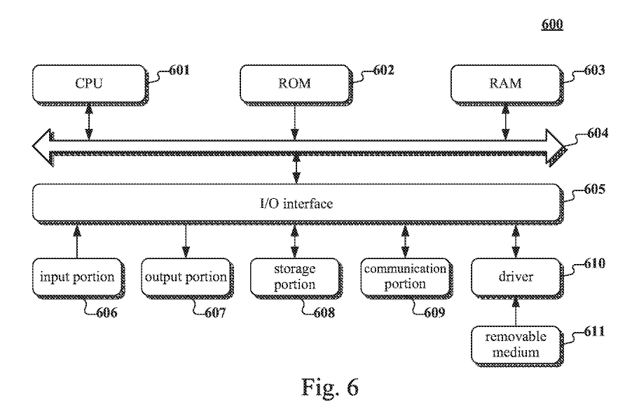

Referring to FIG. 6, a schematic structural diagram of a computer system 600 adapted to implement a terminal device or server of the embodiments of the present disclosure is shown.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse etc.; an output portion 607 comprising a cathode ray tube (CRT), a liquid crystal display device (LCD), a speaker etc.; a storage portion 608 including a hard disk and the like; and a communication portion 609 comprising a network interface card, such as a LAN card and a modem. The communication portion 609 performs communication processes via a network, such as the Internet. A driver 610 is also connected to the I/O interface 605 as required. A removable medium 611, such as a magnetic disk, an optical disk, a magneto-optical disk, and a semiconductor memory, may be installed on the driver 610, to facilitate the retrieval of a computer program from the removable medium 611, and the installation thereof on the storage portion 608 as needed.

In particular, according to an embodiment of the present disclosure, the process described above with reference to the flow chart may be implemented in a computer software program. For example, an embodiment of the present disclosure includes a computer program product, which comprises a computer program that is tangibly embedded in a machine-readable medium. The computer program comprises program codes for executing the method as illustrated in the flow chart. In such an embodiment, the computer program may be downloaded and installed from a network via the communication portion 609, and/or may be installed from the removable media 611. The computer program, when executed by the CPU 601, implements the functions as defined by the methods of the present disclosure.

The flowcharts and block diagrams in the figures illustrate architectures, functions and operations that may be implemented according to the system, the method and the computer program product of the various embodiments of the present disclosure. In this regard, each block in the flow charts and block diagrams may represent a module, a program segment, or a code portion. The module, the program segment, or the code portion comprises one or more executable instructions for implementing the specified logical function. It should be noted that, in some alternative implementations, the functions denoted by the blocks may occur in a sequence different from the sequences shown in the figures. For example, in practice, two blocks in succession may be executed, depending on the involved functionalities, substantially in parallel, or in a reverse sequence. It should also be noted that, each block in the block diagrams and/or the flow charts and/or a combination of the blocks may be implemented by a dedicated hardware-based system executing specific functions or operations, or by a combination of a dedicated hardware and computer instructions.

The units or modules involved in the embodiments of the present disclosure may be implemented by way of software or hardware. The described units or modules may also be provided in a processor, for example, described as: a processor, comprising an acquisition unit and a repairing unit, where the names of these units or modules are not considered as a limitation to the units or modules. For example, the acquisition unit may also be described as “a unit for acquiring a test result of executing a test operation on an unmanned vehicle application in a plurality of test scenarios”.

In another aspect, the present disclosure further provides a non-transitory computer storage medium. The non-transitory computer storage medium may be the non-transitory computer storage medium included in the apparatus in the above embodiments, or a stand-alone non-transitory computer storage medium which has not been assembled into the apparatus. The non-transitory computer storage medium stores one or more programs. The one or more programs, when executed by a device, cause the device to: acquire a test result of executing a test operation on an unmanned vehicle application in a plurality of test scenarios; and perform a repair operation on the unmanned vehicle application by using test scenario data of test scenarios in which a problem is detected in the test result, a container image comprising an operating system-level component required to deploy an operation of a unmanned vehicle component, an image layer of a third-party dependent library, an application code for deploying the unmanned vehicle application and an image layer of an operation environment of the unmanned vehicle application; wherein the repair operation comprises: pushing the test scenario data into the container image to form a to-be-repaired container image and issuing the to-be-repaired container image to a research-development or test terminal to start the research-development or test terminal; receiving a repaired container image uploaded by the research-development or test terminal, wherein the repaired container image is an image generated by repairing the application code of the unmanned vehicle application by a research-development or test staff with the started to-be-repaired container image. Or, the non-transitory computer storage medium stores one or more programs. The one or more programs, when executed by a device, cause the device to: receive a to-be-repaired container image issued from a cloud server, wherein the cloud server is pre-established with a container image comprising an operating system-level component required to deploy an operation of a unmanned vehicle component, an image layer of a container image of a third-party dependent library, an application code for deploying the unmanned vehicle application and an image layer of an operation environment of the unmanned vehicle application, the to-be-repaired container image being an image formed by pushing test scenario data of test scenarios in which a problem is detected during testing into the container image after the cloud server acquires a test result of executing a test operation on the unmanned vehicle application in a plurality of test scenarios; start the to-be-repaired container image; generate a repaired container image after repairing, in response to a repair operation on the application code of the unmanned vehicle application by a research-development or test staff with the started to-be-repaired container image; and upload the repaired container image to the cloud server.

The foregoing is only a description of the preferred embodiments of the present disclosure and the applied technical principles. It should be appreciated by those skilled in the art that the inventive scope of the present disclosure is not limited to the technical solutions formed by the particular combinations of the above technical features. The inventive scope should also cover other technical solutions formed by any combinations of the above technical features or equivalent features thereof without departing from the concept of the invention, such as, technical solutions formed by replacing the features as disclosed in the present disclosure with (but not limited to), technical features with similar functions.

1. A method for developing an unmanned vehicle application, comprising:
acquiring a test result of executing a test operation on an unmanned vehicle application in a plurality of test scenarios; and
performing a repair operation on the unmanned vehicle application by using test scenario data of test scenarios in which a problem is detected in the test result, a container image comprising an operating system-level component required to deploy an operation of a unmanned vehicle component, an image layer of a third-party dependent library, an application code for deploying the unmanned vehicle application and an image layer of an operation environment of the unmanned vehicle application;
wherein the repair operation comprises: pushing the test scenario data into the container image to form a to-be-repaired container image and issuing the to-be-repaired container image to a research-development or test terminal to start the research-development or test terminal; receiving a repaired container image uploaded by the research-development or test terminal, wherein the repaired container image is an image generated by repairing the application code of the unmanned vehicle application by a research-development or test staff with the started to-be-repaired container image.

2. The method according to claim 1, further comprising:
executing a regression test on the unmanned vehicle application of the repaired container image in the plurality of test scenarios.

3. The method according to claim 2, further comprising:
repeating the repair operation, if a problem is detected in the regression test.

4. The method according to claim 1, wherein the acquiring a test result after executing a test operation on an unmanned vehicle application in a plurality of test scenarios comprises:
starting the container image and applying an offline test to the unmanned vehicle application in a plurality of test scenarios simulated by a simulator, respectively; and
acquiring a test result of the offline test in the plurality of test scenarios.

5. The method according to claim 1, wherein the acquiring a test result after executing a test operation on an unmanned vehicle application in a plurality of test scenarios comprises:
acquiring a test result of an on-road test of an unmanned vehicle deployed with the unmanned vehicle application in a plurality of test scenarios.

6. The method according to claim 1, wherein the container image is a Docker image.

7. A method for developing an unmanned vehicle application, comprising:
receiving a to-be-repaired container image issued from a cloud server, wherein the cloud server is pre-established with a container image comprising an operating system-level component required to deploy an operation of a unmanned vehicle component, an image layer of a container image of a third-party dependent library, an application code for deploying the unmanned vehicle application and an image layer of an operation environment of the unmanned vehicle application, the to-be-repaired container image being an image formed by pushing test scenario data of test scenarios in which a problem is detected during testing into the container image after the cloud server acquires a test result of executing a test operation on the unmanned vehicle application in a plurality of test scenarios;
starting the to-be-repaired container image;
generating a repaired container image after repairing, in response to a repair operation on the application code of the unmanned vehicle application by a research-development or test staff with the started to-be-repaired container image; and
uploading the repaired container image to the cloud server.

8-14. (canceled)

15. A device, comprising:
a processor; and
a storage,
wherein the storage stores computer-readable instructions executable by the processor, the instructions, when executed by the processor, cause the processor to perform operations for developing an unmanned vehicle application, and the operations comprises:
acquiring a test result of executing a test operation on an unmanned vehicle application in a plurality of test scenarios; and
performing a repair operation on the unmanned vehicle application by using test scenario data of test scenarios in which a problem is detected in the test result, a container image comprising an operating system-level component required to deploy an operation of a unmanned vehicle component, an image layer of a third-party dependent library, an application code for deploying the unmanned vehicle application and an image layer of an operation environment of the unmanned vehicle application;
wherein the repair operation comprises: pushing the test scenario data into the container image to form a to-be-repaired container image and issuing the to-be-repaired container image to a research-development or test terminal to start the research-development or test terminal; receiving a repaired container image uploaded by the research-development or test terminal, wherein the repaired container image is an image generated by repairing the application code of the unmanned vehicle application by a research-development or test staff with the started to-be-repaired container image.

16. A non-transitory computer storage medium storing computer-readable instructions executable by a processor, the instructions, when executed by the processor, causing the processor to perform operations for developing an unmanned vehicle application, the operations comprising:
acquiring a test result of executing a test operation on an unmanned vehicle application in a plurality of test scenarios; and
performing a repair operation on the unmanned vehicle application by using test scenario data of test scenarios in which a problem is detected in the test result, a container image comprising an operating system-level component required to deploy an operation of a unmanned vehicle component, an image layer of a third-party dependent library, an application code for deploying the unmanned vehicle application and an image layer of an operation environment of the unmanned vehicle application;
wherein the repair operation comprises: pushing the test scenario data into the container image to form a to-be-repaired container image and issuing the to-be-repaired container image to a research-development or test terminal to start the research-development or test terminal; receiving a repaired container image uploaded by the research-development or test terminal, wherein the repaired container image is an image generated by repairing the application code of the unmanned vehicle application by a research-development or test staff with the started to-be-repaired container image.

17. A device, comprising:
a processor; and
a storage,
wherein the storage stores computer-readable instructions executable by the processor, the instructions, when executed by the processor, cause the processor to perform operations for developing an unmanned vehicle application, and the operations comprises:
receiving a to-be-repaired container image issued from a cloud server, wherein the cloud server is pre-established with a container image comprising an operating system-level component required to deploy an operation of a unmanned vehicle component, an image layer of a container image of a third-party dependent library, an application code for deploying the unmanned vehicle application and an image layer of an operation environment of the unmanned vehicle application, the to-be-repaired container image being an image formed by pushing test scenario data of test scenarios in which a problem is detected during testing into the container image after the cloud server acquires a test result of executing a test operation on the unmanned vehicle application in a plurality of test scenarios;
starting the to-be-repaired container image;
generating a repaired container image after repairing, in response to a repair operation on the application code of the unmanned vehicle application by a research-development or test staff with the started to-be-repaired container image; and
uploading the repaired container image to the cloud server.

18. A non-transitory computer storage medium storing computer-readable instructions executable by a processor, the instructions, when executed by the processor, causing the processor to perform operations for developing an unmanned vehicle application, the operations comprising:
receiving a to-be-repaired container image issued from a cloud server, wherein the cloud server is pre-established with a container image comprising an operating system-level component required to deploy an operation of a unmanned vehicle component, an image layer of a container image of a third-party dependent library, an application code for deploying the unmanned vehicle application and an image layer of an operation environment of the unmanned vehicle application, the to-be-repaired container image being an image formed by pushing test scenario data of test scenarios in which a problem is detected during testing into the container image after the cloud server acquires a test result of executing a test operation on the unmanned vehicle application in a plurality of test scenarios;
starting the to-be-repaired container image;
generating a repaired container image after repairing, in response to a repair operation on the application code of the unmanned vehicle application by a research-development or test staff with the started to-be-repaired container image; and
uploading the repaired container image to the cloud server.

19. The device according to claim 15, wherein the operations further comprises:
executing a regression test on the unmanned vehicle application of the repaired container image in the plurality of test scenarios.

20. The device according to claim 19, wherein the operations further comprises:
repeating the repair operation, if a problem is detected in the regression test.

21. The device according to claim 15, wherein the acquiring a test result after executing a test operation on an unmanned vehicle application in a plurality of test scenarios comprises:
starting the container image and applying an offline test to the unmanned vehicle application in a plurality of test scenarios simulated by a simulator, respectively; and
acquiring a test result of the offline test in the plurality of test scenarios.

22. The device according to claim 15, wherein the acquiring a test result after executing a test operation on an unmanned vehicle application in a plurality of test scenarios comprises:
acquiring a test result of an on-road test of an unmanned vehicle deployed with the unmanned vehicle application in a plurality of test scenarios.

23. The device according to claim 15, wherein the container image is a Docker image.
